(19) United States
(12) Patent Application Publication
(10) Pub. No.: US 2013/0188816 A1
(43) Pub. Date: Jul. 25, 2013

(54) METHOD AND HEARING APPARATUS FOR ESTIMATING ONE'S OWN VOICE COMPONENT

(71) Applicant: SIEMENS MEDICAL INSTRUMENTS PTE. LTD., SINGAPORE (SG)

(72) Inventor: VACLAV BOUSE, ERLANGEN (DE)

(73) Assignee: SIEMENS MEDICAL INSTRUMENTS PTE. LTD., SINGAPORE (SG)

(21) Appl. No.: 13/746,515

(22) Filed: Jan. 22, 2013

(30) Foreign Application Priority Data
Jan. 19, 2012 (DE) 10 2012 200 745.8

(51) Int. Cl. H04R 25/00

(52) U.S. Cl. CPC H04R 25/30
USPC 381/320

(57) ABSTRACT

It is possible to identify a hearing apparatus wearer's own voice for signal processing in a hearing apparatus. In a method for estimating one's own voice component, a first microphone is positioned outside the auditory canal and a second microphone is positioned within the auditory canal. The microphone signals are segmented into a number of regions in a time-frequency plane. A region phase difference and a region level difference are then determined respectively for each of the regions from one of the two t-f signals compared with the other of the two t-f signals. All the number of regions of the time-frequency plane, the region phase difference of which corresponds generally to the estimated phase difference and the region level difference of which corresponds generally to the estimated level difference, are then grouped, the signal components of the group serving as an estimation of the voice component.

### CROSS-REFERENCE TO RELATED APPLICATION

This application claims the priority, under 35 U.S.C. §119, of German application DE 10 2012 200 745.8, filed Jan. 19, 2012; the prior application is herewith incorporated by reference in its entirety.

### BACKGROUND OF THE INVENTION

### Field of the Invention

The present invention relates to a method for estimating one's own voice component for a hearing apparatus wearer. The present invention also relates to a hearing apparatus, in which a corresponding method is implemented. The present invention further relates to a hearing apparatus, which has a filter created according to the above method. A hearing apparatus here refers to any device which can be worn on the ear and which generates an auditory stimulus, in particular a hearing device, headset, headphones and the like.

Hearing devices are wearable hearing apparatuses, which serve to assist people with hearing difficulties. To meet the numerous individual requirements, different models of hearing device are available, such as behind the ear hearing devices (BTE), hearing devices with an external earpiece (RIC: receiver in the canal) and in the ear hearing devices (ITE), e.g. also concha hearing devices or canal hearing devices (ITE, CIC). The hearing devices listed by way of example are worn on the outer ear or in the auditory canal. Also available on the market are bone conduction hearing aids, implantable hearing aids and vibrotactile hearing aids. With these the damaged hearing is stimulated either mechanically or electrically.

Hearing devices in principle have the following key components: an input transducer, an amplifier and an output transducer. The input transducer is generally a sound receiver, e.g. a microphone, and/or an electromagnetic receiver, e.g. an induction coil. The output transducer is usually implemented as an electroacoustic converter, e.g. a miniature loudspeaker, or as an electromechanical converter, e.g. a bone conduction earpiece. The amplifier is generally integrated in a signal processing unit. This basic structure is illustrated in FIG. 1 using the example of a behind the ear hearing device. Incorporated in a hearing device housing 1 to be worn behind the ear are one or more microphones 2 for picking up ambient sound. A signal processing unit 3, which is also integrated in the hearing device housing 1, processes and amplifies the microphone signals. The output signal of the signal processing unit 3 is transmitted to a loudspeaker or earpiece 4, which outputs an acoustic signal. The sound is optionally transmitted by way of a sound tube, which is fixed with an otoplastic in the auditory canal, to the eardrum of the device wearer. Energy is supplied to the hearing device and in particular to the signal processing unit 3 by a battery 5, which is also integrated in the hearing device housing 1.

For very many hearing device applications it is necessary or desirable to be able to extract the speech or voice of the wearer of the hearing device or hearing apparatus from the sound environment. One exemplary application would be the active reduction of occlusion effects. A beam shaper can also be controlled based on the wearer's voice. It is also possible to estimate the spatial pulse response on a speech basis.

The speech or speech components of the hearing apparatus wearer can be estimated or extracted using different methods. One very well-known method for this is known as the computational auditory scene analysis (CASA). The CASA principle is based on a computer analysis of the current auditory situation. The CASA principle is based on the ASA principle, the most important achievements of which are summarized in the work of Bregman, A. S. (1994): “Auditory Scene Analysis: The Perceptual Organization of Sound”, Bradford Books. The current state of progress with CASA is set out in the article Wang, D., Brown, G. J. (2006): “Computational Auditory Scene Analysis: Principals, Algorithms and Applications”, published by John Wiley & Sons, ISBN 978-0-471-74109-1.

Monaural CASA algorithms operate on a single signal channel and attempt to separate the sources. Speech should be isolated at least. They are generally based on very stringent requirements in respect of the sound sources. One of these requirements relates for example to the base frequency estimation. Monaural CASA algorithms are also in principle unable to utilize the spatial information from a signal.

Multichannel algorithms try to separate the signals based on the spatial positions of the sources. The microphone configuration is vital to this approach. For example with a binaural configuration, in other words when the microphones are located on both sides of the head, source separation cannot be performed reliably with such algorithms.

### SUMMARY OF THE INVENTION

It is accordingly an object of the invention to provide a method and a hearing apparatus for estimating one's own voice component which overcome the above-mentioned disadvantages of the prior art methods and devices of this general type, which is able to identify a hearing apparatus wearer's voice more reliably.

According to the invention the object is achieved by a method for estimating one's own voice component for a hearing apparatus wearer. The method includes:

positioning a first microphone of the hearing apparatus at the outlet of the auditory canal of a wearer's ear or outside the auditory canal,
positioning a second microphone of the hearing apparatus in the auditory canal, so that the second microphone is closer to the eardrum of the ear than the first microphone,
estimating a phase difference and a level difference of virtual microphone signals from the two microphones in respect of one another based on a predefined model,
each of the two microphones acquiring a temporal microphone signal,
transforming each of the two temporal microphone signals to a t-f signal in the time-frequency plane,
segmenting the time-frequency plane into a number of regions,
determining a region phase difference and a region level difference respectively for each of the regions from one of the two t-f signals compared with the other of the two t-f signals, and
grouping in a group all those of the number of regions of the time-frequency plane, the region phase difference of which corresponds essentially to the estimated phase difference and the region level difference of which corresponds essentially to the estimated level difference, the signal components of the group serving as an estimation of the voice component for the wearer.

According to the invention, a hearing apparatus for performing the above method is also provided, the hearing apparatus has the two microphones and a signal processing facility for transforming, segmenting and grouping.

Two microphones are therefore advantageously positioned in a very specific manner. The second microphone is disposed in the auditory canal, while the first microphone is disposed essentially at the auditory canal outlet or outside the auditory canal (e.g. in the concha or on the pinna). The microphone disposed in the auditory canal can thus pick up many more sound components, which reach the auditory canal by way of bone conduction than the outer microphone. This allows characteristic own voice-based information to be acquired. It is then possible, using a CASA algorithm, to estimate or extract own voice, in other words the voice of the wearer of the hearing apparatus, in which the CASA algorithm is running, in a reliable manner.

At least one further feature that is different from the phase difference and level difference is preferably acquired for each of the microphone signals and used for segmenting and/or grouping. Although in principle grouping is possible solely based on the phase difference and level difference, it is favorable also to use at least one further feature for grouping. In principle other features may be more suitable for segmenting.

The further feature can specifically relate to a change or a change rate in the microphone signal spectrum. This has the advantage that for example fast level rises (ONSETs) at defined frequencies can be readily identified. Such signal edges are suitable for segmenting.

However the further feature can also contain harmonicity (degree of acoustic periodicity) or correlation of the two microphone signals. It is easier to identify speech components directly using harmonicity. Correlation has the advantage that a correlate between externally audible speech and the speech transmitted by way of bone conduction can also be used to define own voice reliably.

The hearing apparatus, which is configured to estimate a voice component according to the above principles, can have a filter, which is controlled based on the grouping or corresponding grouping information from the signal processing facility. The regions in the time-frequency plane determined by grouping are then used in the filter to extract or filter out corresponding signal components, which are then likely to originate from the wearer's voice. The method involving segmenting and grouping can be repeated as required, for example every time the hearing device is switched on. This has the advantage that the filter can then be continuously adjusted for current conditions (e.g. seating of hearing device in or on the ear).

A hearing apparatus can also be provided, which has a filter which serves to extract a hearing apparatus wearer's voice and filters out the signal components, which come within the group of regions acquired previously using a method as described above. The difference in respect of the previous hearing apparatus is therefore that the filter no longer has to be variable and is therefore more economical to produce.

The hearing apparatus can be configured as an in the ear hearing device. Alternatively the hearing apparatus can also be configured as a behind the ear hearing device, which has a hearing device housing to be worn behind the ear and an external earpiece to be worn in the auditory canal or a sound tube for transmitting sound from the hearing device housing into the auditory canal, the second microphone being disposed on the external earpiece or the sound tube and the first microphone being disposed in the hearing device housing. Thus the most up to date models of hearing device can benefit from the inventive manner of estimating own voice.

Other features which are considered as characteristic for the invention are set forth in the appended claims.

Although the invention is illustrated and described herein as embodied in a method and a hearing apparatus for estimating one's own voice component, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is an illustration showing the basic structure of a hearing device according to the prior art;

FIG. 2 is a diagrammatic, cross-sectional view through an auditory canal with an inserted hearing device according to the invention;

FIG. 3 is a block diagram of a CASA algorithm;

FIG. 4 is block diagram from FIG. 3 with internal structures;

FIG. 5 is a graph showing a time-frequency diagram with useful signal regions; and

FIG. 6 is a diagrammatic, sectional view of an ear with an inventively embodied behind the ear hearing device.

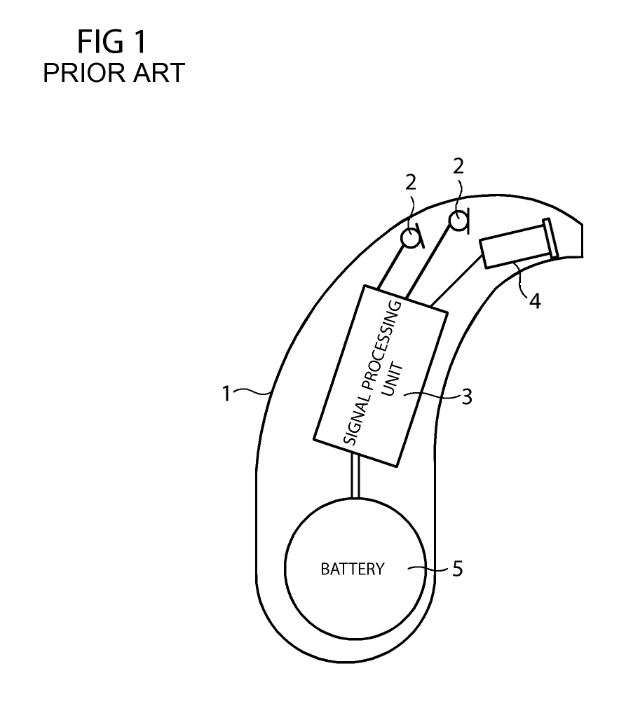

### DETAILED DESCRIPTION OF THE INVENTION

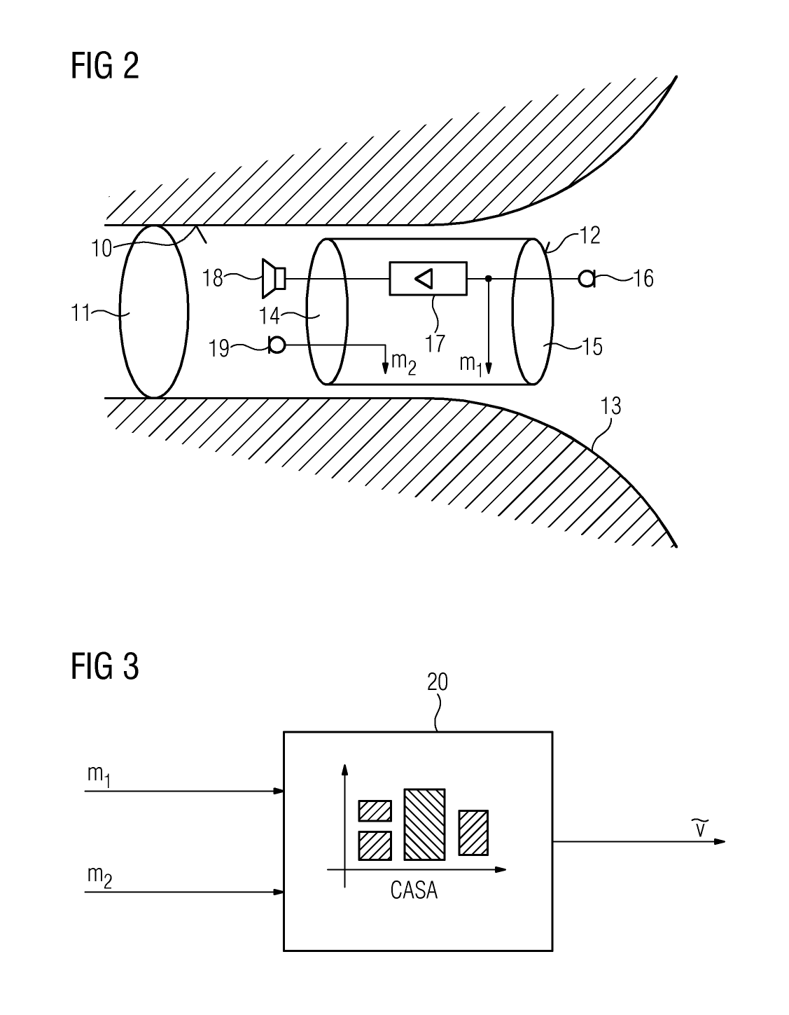

Referring now to the figures of the drawing in detail and first, particularly, to FIG. 2 thereof, there is shown a schematic diagram of an auditory canal 10 with an eardrum 11, with an ITE hearing device 12 inserted into the auditory canal 10. Located at an outlet of the auditory canal 10 is an outer ear 13 (not shown in full here). When inserted into the auditory canal 10, the hearing device 12 has a side 14 facing the eardrum 11 and a side 15 facing outward away from the eardrum.

The hearing device 12 has a first microphone 16 on the side 15 facing outward. This microphone 16 is only shown symbolically outside the hearing device 12. In fact however the microphone is usually in the hearing device or at least on the surface of the hearing device.

The first microphone 16 supplies a microphone signal m₁. The first microphone signal m₁ is used for the computational auditory scene analysis (CASA) algorithm described below. It is however also made available to a standard signal processing facility 17 of the hearing device 12. The standard signal processing facility 17 frequently contains an amplifier. An output signal of the signal processing facility 17 is forwarded to a loudspeaker or earpiece 18, which is disposed on the side 14 of the hearing device 12 facing the eardrum 11. Here too it is only shown symbolically outside the hearing device 12 but is generally in the hearing device housing.

The hearing apparatus or hearing device 12 here has a second microphone 19 in addition to the first microphone 16. The second microphone 19 is also located on the side 14 of the hearing device 12 facing the eardrum 11. It therefore picks up sound, which is produced in the space between the hearing device 12, the eardrum 11 and the wall of the auditory canal 10. The sound of the wearer's voice in particular is also input by way of bone conduction into this often enclosed space. The second microphone 19 picks up the sound as well as others and makes a second microphone signal m₂ available in the hearing device 12. The second microphone 19 can be described as an in the canal microphone.

A CASA system 20, as shown symbolically in FIG. 3, which can be integrated in the hearing device 12, is used to estimate one's own voice or speech, in other words the speech of the hearing device wearer. The CASA system 20 therefore supplies an estimated value \tilde{v} for one's own speech component.

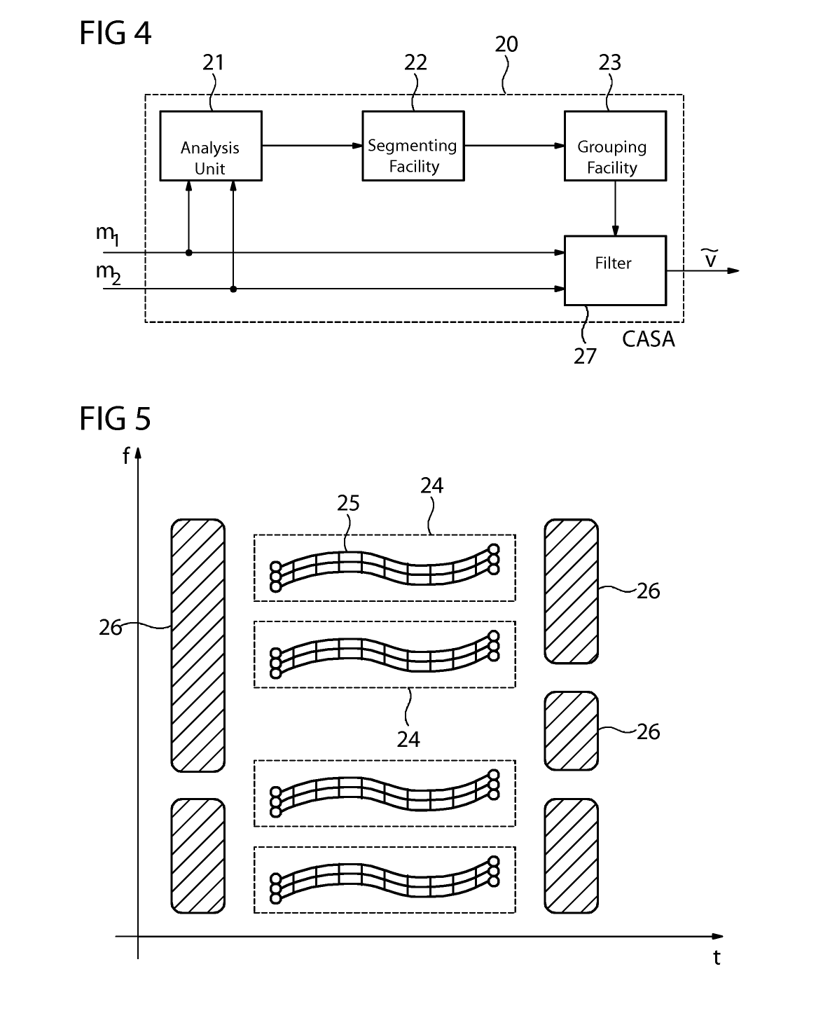

FIG. 4 shows the CASA system 20 from FIG. 3 in detail. In the CASA system 20 the two microphone signals m₁ and m₂ are supplied to an analysis unit 21. The analysis unit 21 investigates each of the microphone signals m₁ and m₂ for specific features. To this end the temporal signals m₁ and m₂ are transformed to the time-frequency range, giving what are known as “t-f signals”, which can also be referred to as short-time spectra. The transformation can be performed by a high-resolution filter bank. Features are then extracted in the analysis facility 21 for each frequency channel of each of the two microphone signals m₁ and m₂. These features are in particular the phase difference and the level difference between the two microphone signals m₁ and m₂, in other words in particular the phase and level difference at each point of the t-f plane of the t-f signals. However the analysis facility 21 can also extract further features from the microphone signals m₁ and m₂. One of the further features can relate to what are known as “onsets”. These refer for example to rapid changes in a spectrum, which are produced typically at the start of a vowel. Such onsets generally represent steep edges in a t-f diagram and are suitable for segmenting the t-f signals.

A further feature extracted by the analysis facility 21 can be harmonicity, which refers to the degree of acoustic periodicity. Harmonicity is frequently used to identify speech. A further feature investigated for example in the analysis facility 21 can be the correlation of the microphone signals m₁ and m₂. In particular the correlation between the sound transmitted into the auditory canal by way of bone conduction and the sound conveyed to the ear from outside can be analyzed. This also provides information relating to the wearer's own speech.

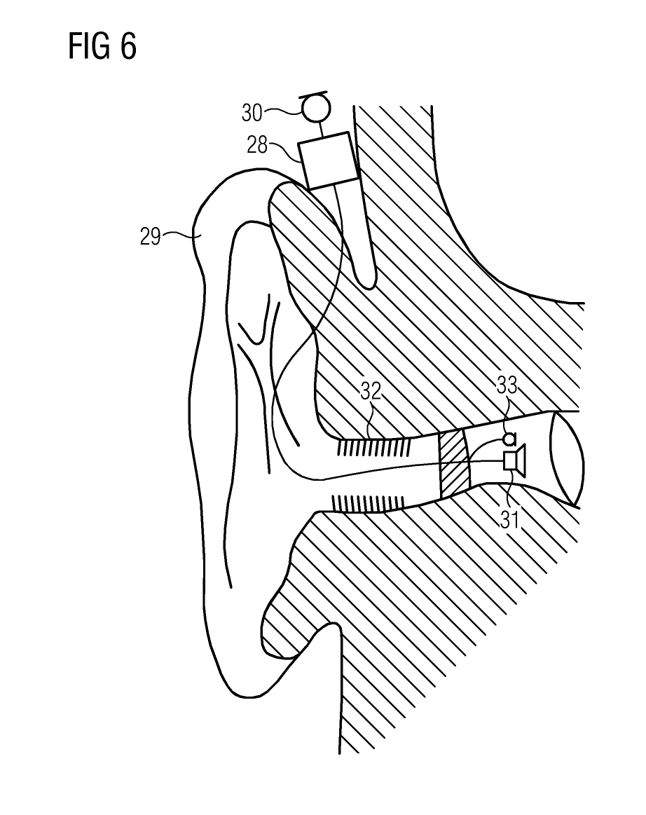

The analysis facility 21 is connected to a segmenting facility 22 on the output side. This segments the short-time spectra of the microphone signals m₁ and m₂. Therefore the segmenting facility 22 calculates boundaries around signal components in the t-f plane in such a manner that regions 24 are defined according to FIG. 5. t-f signal components of a single sound source are present in these regions 24. The regions 24 in the t-f plane for individual sources can be calculated in a variety of known ways. Regions, which can be assigned to a defined source, therefore contain a source sound component 25. Outside the regions 24 are interference sound components 26, which cannot be assigned to a specific source. At the time of segmentation however it is not yet known which region 24 belongs to which specific source. The regions 24 in the t-f plane shown in FIG. 5 are formed for both microphone signals m₁ and m₂.

Connected downstream of the segmenting facility 22 is a grouping facility 23. In the grouping facility 23 of a general CASA system the segmented signal components, i.e. the signal components 25 in the regions 24, are organized in signal streams, which are assigned to the different sound sources. In the present instance only the signal components that belong to the hearing device wearer's own speech are synthesized to form a signal stream. Any regions 24 of the t-f plane can be combined during grouping.

The phase difference and level difference information is used for grouping. In order to be able to decide, based on this information, whether a region belongs to own voice, the phase difference and level difference of the two microphone signals must be estimated computationally beforehand in a model. These estimated values can then be used to determine whether or not one of the segmented regions belongs to one's own voice. If determined phase and level differences lie within a predefined tolerance range around the estimated phase and level differences, the region in question is counted as belonging to one's own voice.

The choice of whether a region 24 is grouped with one or other several regions 24 is made as a function of the phase difference and level difference between the two microphone signals m₁ and m₂. However the further features listed above can also be used for grouping. A group that results in this manner therefore represents all the components of a short-time spectrum, which are to be brought together in order to acquire just own speech or own voice from the plurality of sound components. The other signal components in the short-time spectrum are to be suppressed.

When the regions 24 in the t-f plane for one's own speech have been identified, t-f filtering can be performed. To this end the grouping facility 23 forwards the corresponding grouping information to a filter 27 in the CASA system 20. The filter 27 is thus controlled or parameterized using the grouping information. The filter 27 receives the temporal microphone signals m₁ and m₂, filters the two signals and uses them to acquire an estimation of one's own voice or a component \tilde{v} of one's own voice. The filter here can use the signal components of the regions 24 of both t-f signals of the two microphones or just those of one of the t-f signals of one microphone to reconstruct own voice.

Therefore a specific filter or specific filter information is acquired by segmenting and grouping from the two microphone signals m₁ and m₂, which originate from very specifically disposed microphones 16, 19, and used to filter one's own voice out of an auditory situation characterized by a number of sound sources. There is therefore no need for a specific signal model for own speech.

The inventive system typically has a processing delay of several 100 ms. This delay is necessary to extract the features and group the regions. However such a delay is not a problem in practice.

FIG. 6 shows a further exemplary embodiment relating to the hardware structure of an inventive hearing device. The hearing device here is a BTE hearing device, a main component 28 of which is worn behind the ear, in particular behind a pinna 29. The BTE hearing device has a first microphone 30 on the main component 28. The hearing device here also has what is known as an external earpiece, which is secured in the auditory canal 32. A second microphone 33 is also secured in the auditory canal 32 together with this external earpiece 31. It is thus possible to utilize the inventive extraction or estimation of one's own voice component even with a BTE hearing device.

With the inventive hearing apparatus it is thus possible first to use the CASA principle to register or extract one's voice, as the specific positioning of the microphones means that there is now sufficient spatial information available from the signals. The spatial information can be used to acquire corresponding grouping information so that ultimately there is no need for complicated speech models.

1. A method for estimating a voice component of a wearer of a hearing apparatus, which comprises the steps of:
positioning a first microphone of the hearing apparatus at an outlet of an auditory canal of an ear or outside the auditory canal of the wearer of the hearing apparatus;
positioning a second microphone of the hearing apparatus in the auditory canal, and the second microphone being closer to an eardrum of the ear than the first microphone;
estimating a phase difference and a level difference of virtual microphone signals from the first and second microphones in respect of one another based on a predefined model;
acquiring a temporal microphone signal via each of the first and second microphones;
transforming each of the two temporal microphone signals to a t-f signal in a time-frequency plane;
segmenting the time-frequency plane into a number of regions;
determining a region phase difference and a region level difference respectively for each of the regions from one of the two t-f signals compared with the other of the two t-f signals; and
grouping in a group all of the regions of the time-frequency plane, in which the region phase difference corresponds generally to an estimated phase difference and the region level difference corresponds generally to an estimated level difference, signal components of the group serving as an estimation of the voice component of the wearer.

2. The method according to claim 1, which further comprises acquiring at least one further feature that is different from the phase difference and the level difference for each of the temporal microphone signals and used for at least one of segmenting or grouping.

3. The method according to claim 2, wherein the further feature relates to a change or change rate in a spectrum of the temporal microphone signals.

4. The method according to claim 2, wherein the further feature comprises harmonicity or correlation of the two temporal microphone signals.

5. A hearing apparatus, comprising:
two microphones including a first microphone to be disposed at an outlet of an auditory canal of an ear or outside the auditory canal of a wearer of the hearing apparatus and a second microphone to be disposed in the auditory canal, and said second microphone being closer to an eardrum of the ear than said first microphone;
a signal processing facility for transforming, segmenting and grouping, said signal processing facility programmed to:
estimate a phase difference and a level difference of virtual microphone signals from said first and second microphones in respect of one another based on a predefined model;
acquire a temporal microphone signal via each of said first and second microphones;
transform each of the two temporal microphone signals to a t-f signal in a time-frequency plane;
segment the time-frequency plane into a number of regions;
determine a region phase difference and a region level difference respectively for each of the regions from one of the two t-f signals compared with the other of the two t-f signals; and
group in a group for all the regions of the time-frequency plane, in which the region phase difference corresponds generally to an estimated phase difference and the region level difference corresponds generally to an estimated level difference, signal components of the group serving as an estimation of the voice component of the wearer.

6. The hearing apparatus according to claim 5, wherein said signal processing facility has a filter being controlled based on the grouping of said signal processing facility.

7. The hearing apparatus according to claim 5, wherein the hearing apparatus is an ear hearing device.

8. The hearing apparatus according to claim 5, wherein the hearing apparatus is a behind an ear hearing device, and further comprising:
a hearing device housing to be worn behind the ear; and
an element selected from the group consisting of an external earpiece to be worn in the auditory canal and a sound tube for transmitting sound from said hearing device housing in the auditory canal, said second microphone being disposed on said external earpiece or said sound tube and said first microphone being disposed in said hearing device housing.
